(19) United States
(12) Patent Application Publication
(10) Pub. No.: US 2026/0137178 A1
(43) Pub. Date: May 21, 2026

(54) CUT STONE AND ITS PRODUCTION METHOD

(71) Applicant: Harry Winston SA, Plan-les-Ouates (CH)

(72) Inventors: Erika OGUEY, Divonne-les-Bains (FR); Tobias JENNI, Lancy (CH)

(73) Assignee: Harry Winston SA, Plan-les-Ouates (CH)

(21) Appl. No.: 19/373,913

(22) Filed: Oct. 30, 2025

(30) Foreign Application Priority Data
Nov. 18, 2024 (EP) 24213699.2

(51) Int. Cl. A44C 17/00; B24B 7/22; G04B 45/00

(52) U.S. Cl. CPC A44C 17/001; B24B 7/22; G04B 45/0076

(57) ABSTRACT

A cut stone and its production method, in particular a cut precious or semi-precious stone including a crown topped by a table, a pavilion and a girdle at the intersection of the crown and of the pavilion, of which the surface of facet P2 has a cutting angle comprised between 35° and 45°, of which the surface of facet P4 has a cutting angle comprised between 25° and 35° and of which the ratio between the total height (H) and the diameter or length (L) of said cut precious or semi-precious stone is less than 0.50, preferably comprised between 0.50 and 0.40 and, more specifically, approximately 0.43.

### CROSS REFERENCE TO RELATED APPLICATIONS

This application claims priority to European Patent Application No. 24213699.2, filed on November 18, 2024, the entire contents of which are incorporated herein by reference.

### TECHNICAL FIELD OF THE INVENTION

The present invention relates to the field of cutting precious and semi-precious stones, including diamonds, more specifically for use in the horology or jewellery fields.

### Technological background and prior art

In high-end timepieces, hard materials such as jasper, mother-of-pearl, onyx or precious or semi-precious stones, particularly diamonds, are commonly added to the dial or to other external parts of a timepiece such as a watch or watch clasp, or to a piece of jewellery.

To achieve a particular aesthetic effect, original shapes, including for inlaid work, can be devised. However, these hard materials, especially cut precious or semi-precious stones, must be arranged with a perfect geometry.

Indeed, the optimal insertion of these hard materials as components of the external part, particularly cut precious or semi-precious stones, is a determining factor in the level of quality and finish of a timepiece or a piece of jewellery, and defines the manufacturer's brand image.

When viewed in cross-section, a cut precious or semi-precious stone has an upper part referred to as the crown and a lower part referred to as the pavilion.

The upper part of the crown forms the table; the crown is separated from the pavilion by the girdle and the lower end of the pavilion forms the culet of the cut precious or semi-precious stone.

The sides of both the pavilion and the crown comprise multiple facets, named according to their shape: star, halefi, bezel or table corner on the crown and pavilion or halefi on the pavilion.

Cutting precious or semi-precious stones, particularly diamonds, is both an art and a science. There are certain definitions in the certificate of a cut precious or semi-precious stone, including a diamond, to characterise the cut and the quality of the cut of said stone.

A certificate will show a cross-sectional view of said cut precious or semi-precious stone with its values, as well as the measurement of the angles between the faces and the axis of the length of the cut precious or semi-precious stone. This cut also provides information on the quality of the cut and supplements the cut grading, which is added to the other factors (the 4 Cs for Cut, Colour, Clarity and Carat) demonstrating the quality of the cut precious or semi-precious stone, particularly in the case of a diamond.

A cut precious or semi-precious stone is defined by its proportions, such as its total height (H) measured between the table and the girdle, but also by the crown height (C) and pavilion height (P) of the girdle, when these values are calculated respectively between the table and the diameter (or length (L) measured at the girdle) of the stone and between the girdle and said diameter (or length (L) measured at the girdle) of the cut precious or semi-precious stone. Moreover, a cut precious or semi-precious stone other than a round brilliant is also defined by the smallest diameter (U) of the table and the smallest diameter (or width) (W) of the girdle of the cut precious or semi-precious stone.

The total height (H) or thickness of a cut precious or semi-precious stone is defined in millimetres and is measured between the culet and the table of the cut stone. This value is taken together with the length and width of said cut precious or semi-precious stone, along with the ratio between its total height (H) and its length or width (L or W) to define the characteristics of a cut precious or semi-precious stone, in a certificate.

The quality of the correct proportions of a cut precious or semi-precious stone is measured using a proportionscope, which analyses the efficiency of the light reflected from one facet to another, the dissipation attained and the reflection of light by the table. In fact, light rays penetrate a cut precious or semi-precious stone and the total height of the stone affects the path and reflection of these rays within the cut precious or semi-precious stone.

To obtain maximum brilliance and a maximum cut quality dimension, especially in a diamond, the result will depend on the shape of the cut stone, in particular the absence of known defects, such as an off-centre table, an off-centre pavilion, a culet that is too large, a distorted outline around the girdle, misshapen facets, crown and pavilion misalignment, a wavy girdle, striations or scratches from polishing, but also of the connection with the other facets of said cut stone and therefore of the way in which light will be reflected at the correct angle towards the observer.

Japanese patent application JP 4709088 explains that an ideal cut precious stone (GIA type) has a pavilion cutting angle of 40.75°, a crown cutting angle of 34.5° and a table diameter that is 53% of the diameter of the girdle, as will a cut stone with a pavilion cutting angle (P1) that increases in value, that is, comprised between 40° and 46°, and a crown angle (C) comprised between 14° and 37°.

European patent application EP 1110472 describes, with reference to FIG. 3, a cut precious stone with first crown facets (25), second crown facets (26), third crown facets (27), fourth pavilion facets (28) having cutting angles comprised between 10° and 25°, 10° and 25°, 25° and 35°, 35° and 55° and 25° and 35°, respectively. This patent application also mentions that the third facets (27) and fourth facets (28) can have a cutting angle comprised between 30° and 42° and that facets 27 and 28 respectively have cutting angles comprised between 25° and 35° and between 35° and 55° or between 30° and 42°.

US patent US 11,633,323 describes, with reference to FIG. 4, values for the cutting angles of facets 32 A, 32 B and 34 resulting from supplementary cutting of the base of a cut diamond having a cutting angle comprised between 25° and 60°, preferably between 32° and 38° and between 36° and 42° for the other facets.

UK patent GB 4343652 describes a diamond cut with facets having a cutting angle comprised between 20° and 70°.

Swiss patent CH 713602 describes a small, star-shaped cut stone and the method for producing it to facilitate its insertion in a watch dial, in which the cut facets a, b, c and d on the crown of the cut stone have cutting angles comprised between 15° and 23°, between 18° and 26°, between 24° and 32° and between 36° and 44°, respectively.

However, cut precious or semi-precious stones with an original shape common in the prior art have dimensions, in particular thickness, meaning the total height of the cut precious or semi-precious stone, that are ill-suited to optimum insertion in all timepieces, particularly for arrangement on external parts of a watch such as the flange or back of a dial or on a clasp of a watch or of a wristlet.

In fact, the maximum thickness of the inserted stone will be limited by the thickness of the dial, assuming that the cut stone extends over the entire thickness of the dial, and by the space available between the dial and the hands, so as not to impede the movement of the latter.

Therefore, to achieve optimum integration of a cut precious or semi-precious stone in the flange on a timepiece or in the back of a dial on a timepiece, such as a watch, the challenge is to produce a precious or semi-precious stone of the right size, more specifically a very thin one, meaning with the smallest possible total height, without fracturing it and while retaining the properties of brilliance and aesthetics required to adorn a timepiece, in particular a high-quality watch.

### Purposes of the invention

The present invention aims to produce a cut precious or semi-precious stone, including a diamond, as well as to provide its production method which has none of the drawbacks of the prior art.

The present invention more specifically aims to produce such a cut precious or semi-precious stone, preferably in a marquise or brilliant cut, that has the smallest total height (H) between the culet and the table (T) of the cut stone, while retaining the brilliance properties and attractive aesthetic appearance required for adorning a timepiece, in particular a high-quality watch, or a piece of fine jewellery.

The invention further aims to produce such a cut precious or semi-precious stone that is not embrittled and that can be set in a piece of jewellery.

Lastly, the invention aims to produce a cut precious or semi-precious stone that is true to plan and preferably that has retained the brilliance properties required for its cut to be certified as good, very good, excellent or even ideal quality (according to AGS standards) by an international certification body such as the GIA, AGS, HRD, GSI, EGL, SSEF or GRS.

### SUMMARY OF THE INVENTION

The present invention relates to a cut precious or semi-precious stone, including a diamond, preferably with a fancy cut such as a marquise or brilliant cut.

To these ends, the cut precious or semi-precious stone according to the invention, its production method, and the setting used for it, as well as a dial and a timepiece, in particular a watch, or a piece of jewellery, are defined according to the claims appended hereto.

The inventors have discovered that, in external parts for timepieces, such as the rims or dial backs on timepieces, in particular watches, advantageous use can be made of cut precious or semi-precious stones that advantageously have a reduced overall height and that are therefore advantageously characterised by a ratio between the overall height (H) measured in millimetres and the diameter or length (L) measured in millimetres, of said cut stone, that is less than 0.50, preferably comprised between 0.50 and 0.40, and more specifically approximately 0.43.

The cut precious or semi-precious stone according to the invention comprises a crown topped by a table, a pavilion and a girdle at the intersection of the crown and of the pavilion, and more specifically is such a cut stone that has either a marquise cut or a brilliant cut.

The cut precious or semi-precious stone according to the invention can be a diamond or a gem, in particular a gem chosen among the group consisting of emeralds, rubies and sapphires; but also cut so-called “fine” stones, such as spinel, tourmaline, topaz, amethyst, citrine, peridot, tanzanite, aquamarine or garnets.

In the cut precious or semi-precious stone according to the invention, the surface of facet P2 has a cutting angle comprised between 35° and 45° and the surface of facet P4 has a cutting angle comprised between 25° and 35°.

According to a preferred embodiment of the invention, the cut precious or semi-precious stone according to the invention also has specific cutting surfaces for the other facets with one or more of the characteristics described below:

the surface of facet P1 has a cutting angle comprised between 35° and 45°, preferably of approximately 40°;

the surface of facet P3 has a cutting angle comprised between 25° and 35°, preferably of approximately 30°;

the surface of facet P5 has a cutting angle comprised between 37° and 47°, preferably of approximately 42°;

the surface of facet P6 has a cutting angle comprised between 37.5° and 47.5°, preferably of approximately 42.5°;

the surface of facet P7 has a cutting angle comprised between 38° and 48°, preferably of approximately 42.59°;

According to the invention, “cutting angle of a cut precious or semi-precious stone” is taken to mean the angle in degrees (or °) measured between the surface of a facet or of the pavilion and the plane formed by the girdle on the stone or optionally the plane of the table on the cut stone. The cut precious or semi-precious stone according to the invention is of the fancy type and will have a size and a number of facets corresponding to the generally accepted definition for each type of cut of these cut stones and enabling optimum brilliance and an attractive aesthetic appearance to be imparted to it while ensuring that it is compatible with a setting on a dial or on another high-quality horology or jewellery item.

The present invention also relates to parts for a timepiece or a piece of jewellery incorporating the cut precious or semi-precious stone according to the invention, in particular a clasp or a dial on a timepiece.

These parts for the timepiece or piece of jewellery are preferably fitted with fastening means that are virtually invisible to the user and enable said cut precious or semi-precious stone according to the invention to be attractively displayed.

Another aspect of the invention relates to the method for obtaining the cut precious or semi-precious stone according to the invention, in which either a rough precious or semi-precious stone (including a rough diamond) or a cut precious or semi-precious stone (including a cut diamond) undergoes at least one or more steps in which the faces on the treated stone are polished, in order to obtain the cut precious or semi-precious stone, according to the proportions of the invention.

Initially, a rough or cut precious or semi-precious stone also undergoes the known steps involved in cutting precious or semi-precious stones, comprising cleavage, sawing, rough-cutting and cross-cutting, prior to the polishing step or steps to produce the cut precious or semi-precious stone according to the invention.

The purposes, advantages and characteristics of the invention will be described in detail in the descriptive part with reference to the appended figures, which are presented as preferred and non-limiting illustrations of the invention.

### BRIEF DESCRIPTION OF THE FIGURES

FIGS. 1A to 1F are views of the cut stone according to the invention comprising a crown topped by a table, with a pavilion and a girdle at the intersection of the crown and of the pavilion and in which the various facets or pavilions of the crown and of the pavilion have been numbered.

FIGS. 1A and 1D are, respectively, a cross-sectional view and a lateral view of the numbered facets of a conventional brilliant-cut diamond.

FIGS. 1B, 1C and 1E are lateral views of the numbered facets of the cut stone according to the invention.

FIG. 1F is a perspective view of the same cut stone according to the invention.

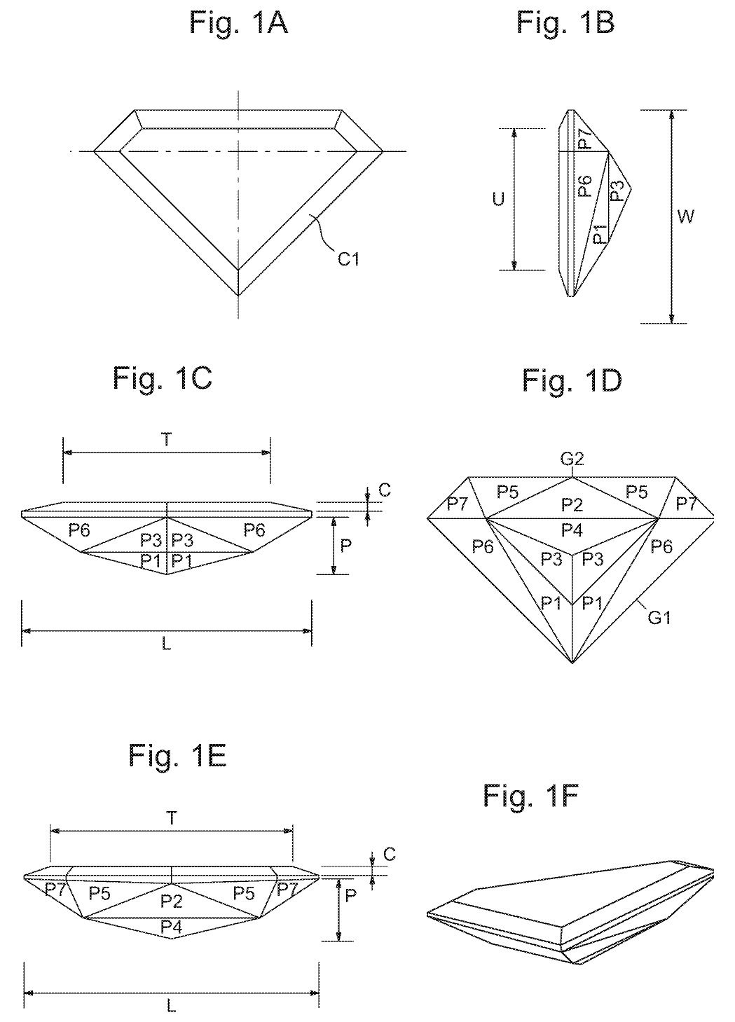

### DETAILED DESCRIPTION OF THE INVENTION

The present invention relates to a cut precious or semi-precious stone and to the method for producing or cutting it, as well as to any timepiece, in particular a watch dial or clasp, or any piece of jewellery on which said cut precious or semi-precious stone is set using fastening means used to fasten said cut precious or semi-precious stone, for example on the dial of a timepiece, in particular on the dial or on the flange of a dial on a watch. This type of cut precious or semi-precious stone according to the invention can also be set, incorporated into a setting and form part of a piece of jewellery.

The invention is more particularly described for a diamond of any type of colour, but it can also relate to any ornamental stone referred to as precious or semi-precious, in particular cut gemstones, meaning not only diamonds, emeralds, rubies and sapphires, but also cut so-called “fine” stones, such as spinel, tourmaline, topaz, amethyst, citrine, peridot, tanzanite, aquamarines, garnets, etc.

The appended figures show several schematic illustrations of a cut precious or semi-precious stone according to the invention. As shown in the appended figures, a cut precious or semi-precious stone according to the invention can be produced, with 12 pavilion facets on the pavilion, 5 girdle facets and 5 + 1 crown facets, for a total of 23 facets.

In the cut precious or semi-precious stone according to the invention, the preferred ratios between the various measurements of the cut precious or semi-precious stone according to the invention as shown in the attached figures are as follows: L/W = 1.56; T/W = 1.280; U/W = 0.759; V/W^3 = 0.172; P/W = 0.318; C/W = 0.047; H/W = 0.383 and P/C = 6.843.

Furthermore, the cut precious or semi-precious stone according to the invention is also characterised by values in degrees (°) of its measured angles. In the table below, the angle values correspond to the cutting angles of the faces (facets or pavilions) of the cut precious or semi-precious stone. According to the invention, a margin or difference of around plus or minus 5° can be provided for the values of the cutting angles in cut precious or semi-precious stones according to the invention.

The cut precious or semi-precious stone according to the invention can be set and inserted into a timepiece and advantageously retains the brilliance properties required for its cut to be certified as being of good, very good, excellent or even ideal quality (according to AGS standards) by an international certification body, such as the GIA, AGS, IGI, HRD, GSI, EGL, SSEF or GRS.

### Facets

G1: 90.00

P1: 40.00

G2: 90.00

P2: 40.00

P3: 30.00

P4: 30.00

P5: 42.00

P6: 42.50

P7: 42.59

T: 0.00 Table

C1: 25.00

25.00

1. A cut precious or semi-precious stone comprising a crown topped by a table, a pavilion and a girdle at the intersection of the crown and of the pavilion, characterised in that the surface of facet P2 has a cutting angle comprised between 35° and 45°, in that the surface of facet P4 has a cutting angle comprised between 25° and 35° and in that the ratio between the total height (H) and the diameter or length (L) of said cut precious or semi-precious stone is less than 0.5.

2. The precious or semi-precious stone according to claim 1 and comprising a ratio between the total height (H) and the diameter or length (L) of said cut precious or semi-precious stone comprised between 0.0-5..4, and more specifically approximately 0.43.

3. The precious or semi-precious stone according to claim 1, in which:
the surface of facet P1 has a cutting angle comprised between 35° and 45°, preferably of approximately 40°;
the surface of facet P3 has a cutting angle comprised between 25° and 35°, preferably of approximately 30°;
the surface of facet P5 has a cutting angle comprised between 37° and 47°, preferably of approximately 42°;
the surface of facet P6 has a cutting angle comprised between 37.5° and 47.5°, preferably of approximately 42.5°;
the surface of facet P7 has a cutting angle comprised between 38° and 48°, preferably of approximately 42.59°.

4. The cut precious or semi-precious stone according to claim 1, characterised in that it has a marquise cut or a brilliant cut.

5. The cut precious or semi-precious stone according to claim 1, characterised in that it is a diamond.

6. The cut precious or semi-precious stone according to claim 1, characterised in that it is a gem.

7. The cut precious or semi-precious stone according to claim 6, characterised in that it is a fine stone chosen among the group consisting of spinel, tourmaline, topaz, amethyst, citrine, peridot, tanzanite, aquamarine and garnets.

8. A part for a timepiece comprising an opening accommodating a setting for the cut precious or semi-precious stone according to claim 1.

9. The timepiece part according to claim 8, characterised in that it is a timepiece frame.

10. A timepiece comprising the cut precious or semi-precious stone or timepiece part according to claim 1.

11. The timepiece according to claim 10, characterised in that it is a watch.

12. A setting comprising a bed for setting the cut precious or semi-precious stone according to claim 1.

13. A piece of jewellery comprising the cut precious or semi-precious stone according to claim 1.

14. A method for producing a cut precious or semi-precious stone according to claim 1, comprising one or more steps in which the faces of a precious or semi-precious stone are polished.
